(19) United States
(12) Patent Application Publication
(10) Pub. No.: US 2019/0203593 A1
(43) Pub. Date: Jul. 4, 2019

(54) Method and System for Modeling in a Subsurface Region

(71) Applicants: Shawn Fullmer, Katy, TX (US); Hisham M. Al-Qassab, Pearland, TX (US); Paul J. Moore, III, Spring, TX (US); Antonio S. Buono, Spring, TX (US); Brian M. Kelley, The Woodlands, TX (US); Bo Gao, Bellaire, TX (US)

(72) Inventors: Shawn Fullmer, Katy, TX (US); Hisham M. Al-Qassab, Pearland, TX (US); Paul J. Moore, III, Spring, TX (US); Antonio S. Buono, Spring, TX (US); Brian M. Kelley, The Woodlands, TX (US); Bo Gao, Bellaire, TX (US)

(21) Appl. No.: 16/215,188

(22) Filed: Dec. 10, 2018

Related U.S. Application Data
(60) Provisional application No. 62/611,660, filed on Dec. 29, 2017.

(51) Int. Cl. E21B 49/00; G01V 99/00

(52) U.S. Cl. CPC E21B 49/00; G01V 99/005

(57) ABSTRACT

A method and system are described for creating subsurface models that accounts for pore type influences. The method includes identifying pore types and properties based on pore types, constructing a subsurface model for a subsurface region and using the subsurface model in simulations and in hydrocarbon operations, such as hydrocarbon exploration, hydrocarbon development, and/or hydrocarbon production.

### CROSS REFERENCE TO RELATED APPLICATION

This application claims the benefit of U.S. Provisional Application Ser. No. 62/611,660, filed Dec. 29, 2017, the disclosure of which is incorporated herein by reference in its entirety.

### FIELD OF THE INVENTION

This disclosure relates generally to methods and systems for creating subsurface models that can be used in the fields of hydrocarbon exploration, hydrocarbon development, and/or hydrocarbon production. Specifically, the disclosure relates to methods and systems for creating subsurface models that account for pore types. The method may include constructing a subsurface model for a subsurface region and using the subsurface model in simulations and in hydrocarbon operations, such as hydrocarbon exploration, hydrocarbon development, and/or hydrocarbon production.

### BACKGROUND

This section is intended to introduce various aspects of the art, which may be associated with exemplary embodiments of the present disclosure. This discussion is believed to assist in providing a framework to facilitate a better understanding of particular aspects of the present invention. Accordingly, it should be understood that this section should be read in this light, and not necessarily as admissions of prior art.

In hydrocarbon operations, such as hydrocarbon exploration, hydrocarbon development, and/or hydrocarbon production operations, different types of subsurface models may be used to represent subsurface structures, which may include a description of the subsurface structures and material properties for the subsurface region. For example, the subsurface model may comprise one or more of a geomechanical model, a geologic model, or a reservoir model. The subsurface model may represent measured or interpreted data for the subsurface region and may include objects (e.g., horizons, faults, surfaces, volumes, and the like). The subsurface model may also be discretized with a mesh or a grid that includes nodes and forms mesh elements (e.g., voxels or cells) within the model. By way of example, the subsurface model may be created from a structural framework (e.g., organization of objects) and provide defined compartments or subvolumes. The geologic model may represent measured or interpreted data for the subsurface region, such as seismic data and well log data. The geologic model may be within a physical space or domain and may have material properties, such as rock properties. The reservoir model may be used to simulate flow of fluids within the subsurface region. Accordingly, the reservoir model may use the same mesh and/or mesh elements as other models, or may resample or upscale the mesh and/or mesh elements to lessen the computations for simulating the fluid flow.

The subsurface model may be used in hydrocarbon operations to predict or estimate how the subsurface region should respond to the hydrocarbon operations. By way of example, the subsurface model may be relied upon for drilling operations to understand fluid behavior and volumes for performing the drilling operations. As another example, the subsurface model may be used to predict the production of hydrocarbons and other fluids from the reservoir. Moreover, the subsurface model may be relied upon to understand the pressures and temperatures within the different regions of the wellbore and/or hydrocarbon field, which may be accessed by different types of wells (e.g., producer wells and/or injector wells).

However, conventional approaches that rely upon subsurface models fail to properly account for pore types. Thus, the subsurface model may not provide understanding for events, such as lost circulation of the drilling fluids, unexplained production behavior that deviates from the predicted subsurface model results, inconsistencies with well tests results, inconsistencies with pressure testing results and unexpected dynamic response that are not predicted by the subsurface model. Accordingly, such conventional subsurface models fail to provide insights to problems or properly model certain subsurface behavior.

Accordingly, there remains a need in the industry for methods and systems that are more efficient and may lessen problems associated with characterizing the subsurface properties in a subsurface model for use in hydrocarbon operations. Further, a need remains for efficient approaches to incorporate pore type into a subsurface model and in simulations that represent fluid flow within the subsurface region. The present techniques provide methods and systems that overcome one or more of the deficiencies discussed above.

### SUMMARY

In one or more embodiments, a method for enhancing hydrocarbon operations for a subsurface region is described. The method comprises: obtaining subsurface data associated with a subsurface region; quantifying pore types based on the subsurface data; creating a pore type distribution based on the quantified pore types; creating one or more property distributions based on the pore type distribution; assigning one or more properties to a subsurface model based on the created one or more property distributions; and outputting the subsurface model along with the one or more properties.

In one or more embodiments, the method may include various enhancements. The method may further comprise identifying the subsurface region for pore type quantification; wherein the one or more property distributions comprise pore type porosity distribution; wherein the one or more property distributions comprise pore type-saturation distribution; wherein the one or more property distributions comprise pore type-permeability distribution; defining dynamic rock types from the quantified pore types, and using the defined dynamic rock types in the creation of the pore type distribution; generating a pore type vertical distribution from the defined dynamic rock types, and using the pore type vertical distribution in the creation of the pore type distribution; wherein the pore type comprise two or more of microporosity, interparticle porosity, separate vugs and touching vugs; creating the subsurface model associated with a subsurface region, wherein the subsurface model comprises a plurality of cells, and assigning one or more of the properties to each of the plurality of cells; simulating fluid flow within the subsurface model based on the one or more properties; causing a well to be drilled based on the one of the outputted properties, the simulated fluid flow, and any combination thereof; and/or performing a hydrocarbon operation based on the one of the outputted properties, the simulated fluid flow, and any combination thereof.

In one or more embodiments, a system for enhancing hydrocarbon operations associated with a subsurface region is described. The system comprising: a processor; an input device in communication with the processor and configured to receive input data associated with a subsurface region; memory in communication with the processor, the memory having a set of instructions. The set of instructions, when executed by the processor, are configured to: obtain subsurface data associated with a subsurface region; quantify pore types based on the subsurface data; create a pore type distribution based on the quantified pore types; create one or more property distributions based on the pore type distribution; assign one or more properties to a subsurface model based on the created one or more property distributions; and output the subsurface model along with the one or more properties.

In one or more embodiments, the system may include various enhancements. The set of instructions, when executed by the processor, may be configured to: identify the subsurface region for pore type quantification; define dynamic rock types from the quantified pore types, and use the defined dynamic rock types in the creation of the pore type distribution; generate a pore type vertical distribution from the defined dynamic rock types, and use the pore type vertical distribution in the creation of the pore type distribution; quantify the pore type into two or more of microporosity, interparticle porosity, separate vugs and touching vugs; create a subsurface model associated with a subsurface region, wherein the subsurface model comprises a plurality of cells, and assign one or more of the properties to each of the plurality of cells; and/or simulate fluid flow within the subsurface model based on the one or more properties.

### BRIEF DESCRIPTION OF THE DRAWINGS

The advantages of the present invention are better understood by referring to the following detailed description and the attached drawings.

FIG. 1 is an exemplary flow chart in accordance with an embodiment of the present techniques.

FIG. 2 is a block diagram of a computer system that may be used to perform any of the methods disclosed herein.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

The articles “the”, “a”, and “an” are not necessarily limited to mean only one, but rather are inclusive and open ended so as to include, optionally, multiple such elements.

As used herein, the term “hydrocarbons” are generally defined as molecules formed primarily of carbon and hydrogen atoms such as oil and natural gas. Hydrocarbons may also include other elements or compounds, such as, but not limited to, halogens, metallic elements, nitrogen, oxygen, sulfur, hydrogen sulfide (H₂S), and carbon dioxide (CO₂). Hydrocarbons may be produced from hydrocarbon reservoirs through wells penetrating a hydrocarbon containing formation. Hydrocarbons derived from a hydrocarbon reservoir may include, but are not limited to, petroleum, kerogen, bitumen, pyrobitumen, asphaltenes, tars, oils, natural gas, or combinations thereof. Hydrocarbons may be located within or adjacent to mineral matrices within the earth, termed reservoirs. Matrices may include, but are not limited to, sedimentary rock, sands, silicilytes, carbonates, diatomites, and other porous media.

As used herein, “hydrocarbon exploration” refers to any activity associated with determining the location of hydrocarbons in subsurface regions. Hydrocarbon exploration normally refers to any activity conducted to obtain measurements through acquisition of measured data associated with the subsurface formation and the associated modeling of the data to identify potential locations of hydrocarbon accumulations. Accordingly, hydrocarbon exploration includes acquiring measurement data, modeling of the measurement data to form subsurface models, and determining the likely locations for hydrocarbon reservoirs within the subsurface. The measurement data may include seismic data, gravity data, magnetic data, electromagnetic data, and the like.

As used herein, “hydrocarbon development” refers to any activity associated with planning of extraction and/or access to hydrocarbons in subsurface regions. Hydrocarbon development normally refers to any activity conducted to plan for access to and/or for production of hydrocarbons from the subsurface formation and the associated modeling of the data to identify preferred development approaches and methods. By way of example, hydrocarbon development may include modeling of the subsurface formation and extraction planning for periods of production, determining and planning equipment to be utilized and techniques to be utilized in extracting the hydrocarbons from the subsurface formation, and the like.

As used herein, “hydrocarbon operations” refers to any activity associated with hydrocarbon exploration, hydrocarbon development and/or hydrocarbon production.

As used herein, “hydrocarbon production” refers to any activity associated with extracting hydrocarbons from subsurface location, such as a well or other opening.

Hydrocarbon production normally refers to any activity conducted to form the wellbore along with any activity in or on the well after the well is completed. Accordingly, hydrocarbon production or extraction includes not only primary hydrocarbon extraction, but also secondary and tertiary production techniques, such as injection of gas or liquid for increasing drive pressure, mobilizing the hydrocarbon or treating by, for example, chemicals, hydraulic fracturing the wellbore to promote increased flow, well servicing, well logging, and other well and wellbore treatments.

As used herein, “subsurface model” refers to a model of a subsurface region and may include a reservoir model, geomechanical model, and/or a geologic model. The subsurface model may include subsurface data distributed within the model in two-dimensions (2D) (e.g., distributed into a plurality of cells, such as mesh elements or blocks), three-dimensions (3-D) (e.g., distributed into a plurality of voxels), or more dimensions.

As used herein, a “geologic model” is a subsurface model (e.g., a 2D model or a 3-D model) of the subsurface region having static properties and includes objects, such as faults and/or horizons, and properties, such as facies, lithology, porosity, permeability, or the proportion of sand and shale.

As used herein, a “reservoir model” is a subsurface model (e.g., a 2-D model or a 3-D model) of the subsurface that in addition to static properties, such as porosity and permeability, also has dynamic properties that vary over the timescale of resource extraction, such as fluid composition, pressure, and relative permeability.

As used herein, a “geomechanical model” is a model (e.g., a 2-D model or a 3-D model) of the subsurface that contain properties, such as static properties and may model responses to changes in stress, such as mechanical response. The static properties may include properties, such as rock compressibility and Poisson's ratio, while the mechanical response may include compaction, subsidence, surface heaving, faulting, and seismic events, which may be a response to fluid injection and extraction from the subsurface region.

As used herein, “structural framework” or “framework” refer to a subsurface representation formed from objects (e.g., faults, horizons, other surfaces and model boundaries). For example, the framework is a subsurface representation that contains surfaces and polylines. A framework may be formed by surfaces of geologic, engineering, planning, or other technical relevance.

As used herein, “zone”, “region”, “container”, or “compartment” is a defined space, area, or volume contained in the framework or model, which may be bounded by one or more objects or a polygon encompassing an area or volume of interest. The volume may include similar properties.

As used herein, “mesh” or “grid” is a representation of a region of space (e.g., 2-D domain or 3-D domain), which includes nodes that may form mesh elements, such as polygons or polyhedra, disposed within the region (e.g., a volumetric representation). The mesh may represent surfaces, horizons, faults, and/or other objects by a set of nodes, which may include various mesh elements in the form of polygons or polyhedra, disposed within the region. Properties may be assigned to or associated with the mesh elements.

As used herein, “simulate” or “simulation” is the process of performing one or more operations using a subsurface model and any associated properties to create simulation results. For example, a simulation may involve computing a prediction related to the resource extraction based on a reservoir model. A reservoir simulation may involve performing by execution of a reservoir-simulator computer program on a processor, which computes composition, pressure, and/or movement of fluid as a function of time and space for a specified scenario of injection and production wells by solving a set of reservoir fluid flow equations. A geomechanical simulation may involve performing by execution of a geomechanical simulator computer program on a processor, which computes displacement, strain, stress, shear slip, and/or energy release of the rock as a function of time and space in response to fluid extraction and injection.

In hydrocarbon operations, a subsurface model is created in the physical space or domain to represent the subsurface region. The subsurface model is a computerized representation of a subsurface region based on geophysical and geological observations made on and below the surface of the Earth. The subsurface model may be a numerical equivalent of a reservoir map (e.g., 2-D reservoir map or 3-D reservoir map) complemented by a description of physical quantities in the domain of interest. The subsurface model may include multiple dimensions and may be delineated by objects, such as horizons, fractures, and faults. The subsurface model may include a structural framework of objects, such as faults, fractures, and horizons. Within the subsurface models, a grid or mesh may be used to partition the model into different subvolumes, which may be used in hydrocarbon operations, such as reservoir simulation studies in hydrocarbon exploration, development, and/or production operations, as well as for representing a subsurface model description of a reservoir structure and material properties. The subsurface model may include a mesh or grid of nodes to divide the structural framework and/or subsurface model into mesh elements, which may include cells or blocks in 2-D, or voxels in 3-D, or other suitable mesh elements in other dimensions. Accordingly, the mesh may be configured to form mesh elements that may represent material properties, such as rock and fluid properties, of a reservoir or may be used for numerical discretization of partial differential equations, such as fluid flow or wave propagation.

To enhance the understanding of the subsurface regions represented by the subsurface model, reservoir simulations may be performed. For example, the reservoir simulations may be relied upon to determine well locations, well orientations, specific regions that may be used to economically produce hydrocarbons from a subsurface region. Further, the reservoir simulations may be used to enhance hydrocarbon operations associated with that subsurface region, which may include asset acquisition evaluation, selection of drill site and completion zones and/or equipment, and/or stimulation or injection planning.

To further refine subsurface models and/or to enhance the creation of subsurface models, additional measurements or monitoring may be performed to lessen uncertainty in the subsurface model. By way of example, seismic data, resistivity data and/or gravitational data may be used to provide information about the subsurface region, such as structural features. In addition, core samples, special core analysis, thin section data, well logs, and/or well tests may provide additional information about the porosity and permeability within the subsurface region.

As an enhancement, the present techniques create a subsurface model by accounting for the different pore types, which each influence fluid flow in different degrees. The pore types may be categorized as, but not limited to microporosity, interparticle porosity, separate vugs, and touching vugs, for example. The pore type impacts the fluid flow within subsurface regions, such as reservoirs. For example, two subsurface region may have the same porosity but different pore types, and in such a case, the different pore types may affect the fluid flow for these different subsurface regions. For example, carbonates are more challenging with regard to distribution of properties, such as porosity and permeability. As a result, it may be desirable to use dynamic data to further enhance the pore type within the model. In contrast, conventional approaches do not address pore type and do not integrate dynamic data. In the present techniques, the development of pore types early in the process and the reliance on the pore types through the creation of the subsurface model enhances the hydrocarbon operations.

The present may involve various steps that integrate pore type into the creation and use of a subsurface model. Further, the integration of pore type into the subsurface model may aid in resolving issues with current hydrocarbon operations. By way of example, the present techniques may involve identifying a subsurface region for pore type analysis. This identification (i.e., the identification of a subsurface region of interest) may be based on the identification of problems for the subsurface region and/or may be part of the preferred approach to construct a subsurface model for a subsurface region. The problems in the subsurface region may include various symptoms, such as surveillance issues (e.g., inconsistencies from various surveillance tests, such as production logging tool (“PLT”), pulsed neutron log (“PNL”), and/or modular formation dynamics tester (“MDT”) tests); unexplained production behavior; dynamic response not predicted by the subsurface model; dynamic inconsistencies with well tests and/or pressures; identification of non-geologic control of the subsurface region; drilling data losses and/or bit-drops; inconsistencies between geology and dynamic data; and/or inconsistencies between well performance predictions and performance. Further, the identification of a subsurface region for pore type analysis may include determining or evaluating the subsurface data at the location and determining whether pore type analysis is needed for the region. This determination may be based on the rock type in the region and/or other geologic identifiers. If such problems are identified or a region is identified, the pore type analysis may be utilized to enhance the subsurface model and resulting hydrocarbon operations.

The present techniques include identifying the pore type, which may be identified from direct subsurface measurements or may be inferred. The identifying pore types may include defining pore types, which may be categorized as but not limited to microporosity, interparticle porosity, separate vugs, and/or touching vugs. For example, the pore type data associated with a subsurface region may first be quantified. The quantification of the pore type data associated with a subsurface region may include determining bins for the pore types and dividing the pore type data into the respective bins. This binning of the pore types may then be used through entire process based on this binning. The direct subsurface measurements may include analyzing quantitative digital petrography (“QDP”); analyzing conventional core analysis (“CCAL”) or routine core analysis (“RCA”) integration; analyzing mercury injection cap pressure (“MICP”); analyzing special core analysis (“SCAL”), which may include capillary pressure (“Pc”) and relative permeability (“Kr”); analyzing nuclear magnetic resonance (“NMR”); analyzing logs, such as cased hole logs; and/or analyzing PLT. The terms CCAL and SCAL are known in the art. In some embodiments, the term CCAL and/or RCA refer to core analysis that may include the measurement of basic reservoir/petrophysical properties such as porosity, permeability, rock and/or grain density, salinity and may include fluid saturation testing by dean stark method, CT scanning. In some embodiments, the term SCAL refers to core analysis that may provide an idea of the quality of the rock, the wetting nature of the reservoir rock and may include the measurement of capillary pressure, relative permeability, wettability, rock fluid sensitivity.

The inferring of pore types may include analyzing analog; analyzing depositional and diagenetic data; analyzing log motif, which may be data specific; and/or analyzing dynamic data, such as PLT, PNL, resistivity log (“RST”), and/or MDT data. By way of example, the pore types may be defined in a variety of approaches. The defining of pore types may include analyzing (1) porosity and permeability data that are acquired from the rock sample; and/or (2) quantitative digital petrography performed on a thin section, which may include scanning the thin section and then breaking the thin section into its component parts using image analysis software. The pore type analysis may involve isolating pores from cement and grains and identifying macro pores and micropores. Total porosity from the core analysis data may also be used to calculate percentage of micro porosity. The range for the micro porosity may be defined as less than 50 microns, less than 30 microns, less than 20 microns, less than 10 microns, or less than 1 micron. This range can be adjusted based on data from a field or image resolution.

Then, the present techniques may perform pore types translation. Pore type translation may include defining pore types as described above for areas with dynamic data which then can be translated to areas with sparser data. For example, a first well may have core, but the second well may not have core data. As such, the first well is used to determine a dynamic rock type scheme that may be used to translate it to the second well and the space between using data that can be found to do the translation. By way of example, the pore type translation may include associating pore types with mappable elements; performing thresholding; performing NMR log translations; performing log motif analysis; performing depositional and diagensis analysis; performing PLTs, cased hole logs, or other downhole data analysis; and/or performing property integration (e.g., porosity mapping) analysis.

The present techniques may also perform a pore type flow characterization. The pore type flow characterization may include determining flow characteristics; defining dynamic rock types; performing dynamic integration and/or validation; performing SCAL analysis; performing a PLT analysis; and/or performing a permeability thickness (“Kh”) from well tests and/or PLT.

With the pore type flow characterization, the vertical distribution of pore types may be performed. The method may include performing a vertical distribution based on subsurface data and/or extrapolating the vertical distribution based on predicted distributions. By way of example, the performing a vertical distribution may include building a petrophysical rock type (“PRT”) log, which may include discrete logs; evaluating vertical patterns for geologic intervals; and/or evaluating vertical heterogeneity and/or connectivity. The extrapolation of the vertical distribution may include using subsurface data to predict distributions for uncored regions and/or regions where the data is sparse or not present. The extrapolation may include performing a log motif extrapolation; performing a quantitative finite element (“FE”) core to log analysis; performing a PLT, cased hole log extrapolation and/or vertical PRT assignment; and/or performing a blind test validation against core and/or PLT results.

In addition, the present techniques may distribute the pore types within the subsurface region. The distribution of pore type may involve performing a 2D or 3D pore type distribution. The pore type distributions may involve performing a kriging of the pore types and/or performing a stochastic simulation and/or distribution of the pore type. The kriging of the pore type may include performing a validation with dynamic data against pressure buildup, PLTs, average porosity map, and/or water cut maps, for example. The performing a stochastic simulation and/or distribution of pore types may include performing a zonal Kh from total pressure buildups; calculating azimuthal variogram from zonal Kh; and/or simulating pore type using Kh as soft data and/or azimuthal variograms.

From the pore type distribution, various properties may be distributed. For example, the present techniques may perform a porosity distribution; may perform a pore type saturation distribution; and/or may perform a pore type-permeability distribution. The performing a porosity distribution may include building and/or leveraging different porosity distributions. These distributions may be based solely on wells and/or pore type based distributions.

The performing a pore type-saturation distribution (e.g., 2-D or 3-D) may include performing a saturation distribution, which may be consistent with saturation modeling by pore type based on imbibition and drainage. The performance may involve binning the saturation data, which may use numerous tests. The method may bin the data by pore types then assign them to the appropriate cell.

The performing the pore type-permeability distribution may include performing core based permeability modeling and/or conditioning the permeability model to dynamic data. The core based permeability modeling may include establishing core based porosity and/or permeability by pore type relationships; and/or creating a permeability distribution by pore type (e.g., 2-D or 3-D). The conditioning of the permeability model to dynamic data may include performing a zonal Kh model versus pressure buildup Kh analysis; and/or performing an integration Kh model with zonal Kh.

Then, the present techniques may include creating a pore type framework. The creation may include forming a framework; correlating Pc data and/or Kr data to static properties along with pore type distribution (e.g., micro percentage); selecting framework by pore type; validating with fraction flow analysis; and/or baffling and/or forming a barrier for SCAL considerations. Further, the method may include assigning the properties may involve calibrating pore type to dynamic data. The calibration may involve performing a comparison using subsurface data, such as well test data. The calibration may involve additional subsurface data depending on the development of the subsurface region or field. The creation of the pore type framework may be reiterated to refine the framework until it is within a threshold. The reiteration may involve adjusting the framework structure and/or properties and re-assigning properties and/or adjusting the properties based on the adjustments. By way of example, the inflow data from PLTs may be reviewed and used to assign the inflow to a specific interval in the well, which has already had its pore type characterized. This provides a mechanism to calibrate the dynamic response of the well to a specific dynamic rock type, which may then be populated in the model.

Once the pore type framework is created, subsurface modeling or dynamic modeling may be performed. The subsurface modeling may include creating a subsurface model that represents the subsurface region, assigning the properties based on the pore types (e.g., pore type permeability, pore type saturation, and/or pore type porosity) within the subsurface model; initializing the subsurface model for a simulation, performing a simulation (e.g., for various time steps); and/or outputting the results of the simulation, which may be stored in memory and/or displayed. The creation of the subsurface model may also include establishing a baseline and/or benchmarking. Optionally, the subsurface modeling may include calculating an objective function result from an objective function, adjusting the properties in the subsurface model and re-performing the simulation until the objective function result is below a threshold. In addition, subsurface modeling may include performing a sensitivity analysis. The sensitivity analysis may involve performing multiple realizations while only changing one parameter to determine how the model responds to the changes in input data.

Once the modeling is complete, the hydrocarbon operations may be performed based on the simulation results. The hydrocarbon operations may include field development, which may involve determining the placement of one or more wells and/or determining a completion strategy for each of the respective wells. In addition, the hydrocarbon operations may include determining production feasibility, field development forecasting, field development options, and/or determining performance forecasts.

Accordingly, the present techniques may enhance the generation of subsurface models. For example, in one or more configurations, a method for enhancing hydrocarbon operations for a subsurface region is described. The method comprises: obtaining subsurface data associated with a subsurface region; quantifying pore types based on the subsurface data; creating a pore type distribution based on the quantified pore types; creating one or more property distributions based on the pore type distribution; assigning one or more properties to a subsurface model based on the created one or more property distributions; and outputting the subsurface model along with the one or more properties.

In one or more configurations, the method may include various enhancements. The method may further comprise identifying the subsurface region for pore type quantification; wherein the one or more property distributions comprise pore type porosity distribution; wherein the one or more property distributions comprise pore type-saturation distribution; wherein the one or more property distributions comprise pore type-permeability distribution; defining dynamic rock types from the quantified pore types, and using the defined dynamic rock types in the creation of the pore type distribution; generating a pore type vertical distribution from the defined dynamic rock types, and using the pore type vertical distribution in the creation of the pore type distribution; wherein the pore type comprise two or more of microporosity, interparticle porosity, separate vugs and touching vugs; creating the subsurface model associated with a subsurface region, wherein the subsurface model comprises a plurality of cells, and assigning one or more of the properties to each of the plurality of cells; simulating fluid flow within the subsurface model based on the one or more properties; causing a well to be drilled based on the one of the outputted properties, the simulated fluid flow, and any combination thereof; and/or performing a hydrocarbon operation based on the one of the outputted properties, the simulated fluid flow, and any combination thereof.

In yet another configuration, a system for enhancing hydrocarbon operations associated with a subsurface region is described. The system comprising: a processor; an input device in communication with the processor and configured to receive input data associated with a subsurface region; memory in communication with the processor, the memory having a set of instructions. The set of instructions, when executed by the processor, are configured to: obtain subsurface data associated with a subsurface region; quantify pore types based on the subsurface data; create a pore type distribution based on the quantified pore types; create one or more property distributions based on the pore type distribution; assign one or more properties to a subsurface model based on the created one or more property distributions; and output the subsurface model along with the one or more properties.

In one or more configurations, the system may include various enhancements. The set of instructions, when executed by the processor, may be configured to: identify the subsurface region for pore type quantification; define dynamic rock types from the quantified pore types, and use the defined dynamic rock types in the creation of the pore type distribution; generate a pore type vertical distribution from the defined dynamic rock types, and use the pore type vertical distribution in the creation of the pore type distribution; quantify the pore type into two or more of micro porosity, interparticle porosity, separate vugs and touching vugs; create a subsurface model associated with a subsurface region, wherein the subsurface model comprises a plurality of cells, and assign one or more of the properties to each of the plurality of cells; and/or simulate fluid flow within the subsurface model based on the one or more properties.

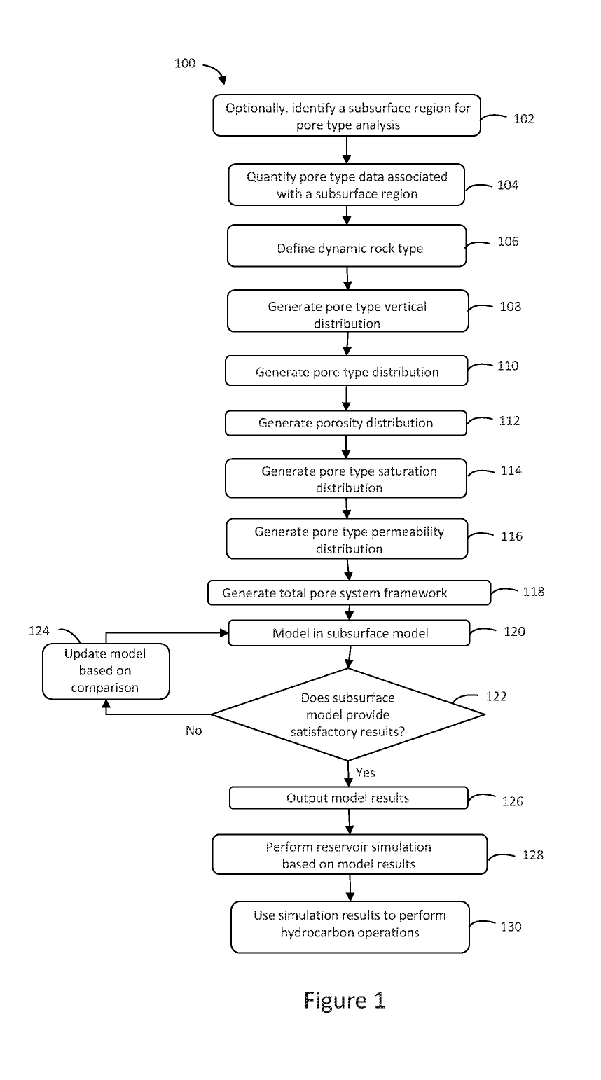

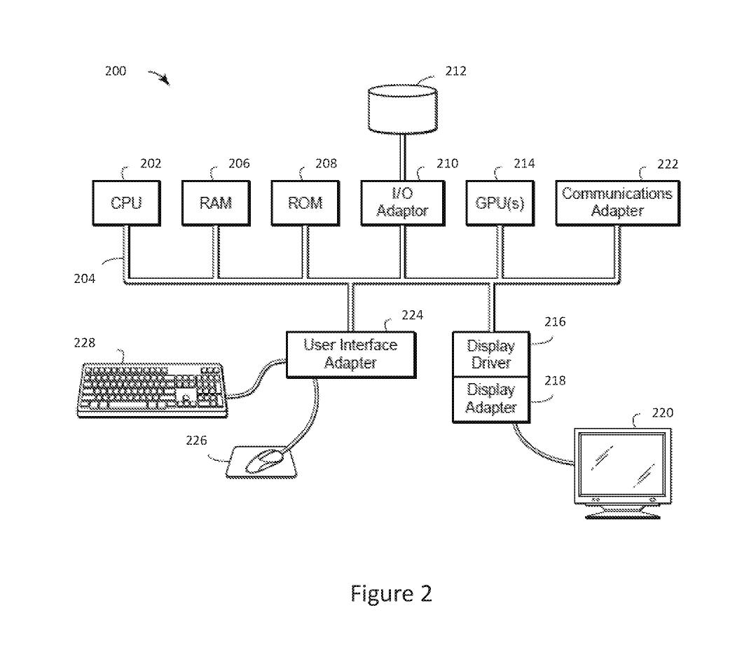

Beneficially, the present techniques provide various enhancement for the creation and use of subsurface models. The pore type data links the dynamic SCAL and geologic data into direct inputs for the simulation model. The present techniques may be further understood with reference to the FIGS. 1 to 2 below.

FIG. 1 is an exemplary flow chart 100 in accordance with an embodiment of the present techniques. The flow chart 100 includes a method for creating subsurface models that accounts for the influence of pore types on properties. The method may include obtaining subsurface measurements, performing pore type analysis, generating property distributions, constructing a subsurface model for the subsurface region and using the subsurface model in simulations and in hydrocarbon operations, such as hydrocarbon exploration, hydrocarbon development, and/or hydrocarbon production. In particular, the method may include obtaining subsurface measurements and analyzing the pore types for a subsurface region, as shown in blocks 102 to 110, and generating the property distributions, as shown in blocks 112 to 116. Then, the framework and subsurface model are created to account for pore types, which is used in simulations and the results are used to perform hydrocarbon operations, as shown in blocks 118 to 130.

To begin, the method may include obtaining subsurface measurements and analyzing the pore types for a subsurface region, as shown in blocks 102 to 110. At block 102, a subsurface region may be identified for pore type analysis. The identification of the subsurface region for pore type analysis may include identifying subsurface regions that are associated with lost circulation and/or other anomalous drilling events; identifying subsurface regions that are associated with surveillance issues; identifying subsurface regions that are associated with unexplained production behavior; identifying subsurface regions that are associated with dynamic response not predicted by an associated subsurface model; and/or identifying subsurface regions that are associated with dynamic inconsistencies well tests and/or pressure. At block 104, pore type data associated with a subsurface region is quantified. The quantification of the pore type data associated with a subsurface region to determine bins for the pore types and divide the pore type data into the respective bins. This binning of the pore types may then be used through entire process based on this binning. By way of example for limestone, the binning may be based on certain ranges, such as micro porosity being using about 80 percent (%) micro porosity as a cutoff. Other differentiators may be greater than (>) 80% micro porosity as a percent of total porosity flows one direction, while less than (<) 80% tends to have higher permeabilities, but also has a higher endpoint saturation. While these percentages may be used for limestones, other rocks may use other features to quantify the pore types. For example, dolomite may rely upon the grain size to form different pore type ranges. Further, the percentages may be refined or adjusted based on the core samples from the area or analogs from similar locations. Then, at block 106, dynamic rock type may be defined. The defining of the rock types may integrate pore type bins or classifications with dynamic data, such as SCAL (special core analysis), production logging tool (PLT), and/or well test. At block 108, a pore type vertical distribution may be generated. The pore type vertical distribution may be a 2D or 3D distribution of the pore types. The generation of the pore type vertical distribution may include mapping the pore type within a wellbore. At block 110, a pore type distribution may be generated. The pore type distribution may be a 2D or 3D distribution of the pore types.

Once the pore type distribution is created, the respective properties may be determined, as shown in blocks 112 to 116. At block 112, porosity distribution is generated. The porosity distribution may be a 2D or 3D distribution. The generation of the porosity distribution may include computing the porosity for the region, which may be based on the different pore types. At block 114, the pore type saturation distribution is generated. The pore type saturation distribution may be a 2D or 3D distribution. The generation of the pore type saturation distribution may include computing the saturation for the region, which may be based on the different pore types. At block 116, the pore type permeability distribution is generated. The pore type permeability distribution may be a 2D or 3D distribution. The generation of the pore type permeability distribution may include computing the permeability for the region, which may be based on the different pore types. In addition, the pore type permeability distribution may be conditioned to dynamic data. This may involve performing a core based permeability approach and/or conditioning dynamic data (e.g., pressure buildups from well tests, zonal Kh maps, PLTs), which may be used to honor the data from the well.

Once the property distributions are determined, the framework and subsurface model are created to account for pore types, which is used in simulations and the results are used to perform hydrocarbon operations, as shown in blocks 118 to 130. At block 118, total pore system framework is generated. The generation of the total pore system framework may include defining boundaries, and objects with the boundaries. At block 120, the subsurface model is modeled. The modeling of the subsurface model may include creating a subsurface model to represent the subsurface region; and assigning the properties to the subsurface model (e.g., porosity, saturation and/or permeability, which are based on pore types). In addition, the modeling the subsurface model may include performing a simulation with the subsurface model using the properties, performing calculations with the properties in the subsurface model and/or performing a forward modeling with the with the properties in the subsurface model. The subsurface model may be created based on measurement data or accessed from memory. The measurement data may include seismic data, resistivity data, gravity data, well log data, core sample data, and combinations thereof. The subsurface model may include geologic features, such as horizons and faults. By way of example, the creation of the subsurface model may include using the total pore system framework to form a structural framework of objects (e.g., surfaces, such as faults, horizons, and if necessary, additional surfaces that bound the area of interest for the model), verifying or forming the objects into closed volumes, meshing or partitioning the volume into sub-volumes (e.g., cells, mesh elements or voxels) defined by a mesh (e.g., a three dimensional (3-D) mesh or 3-D grid), and assigning properties to the mesh elements. The properties may include porosity and/or permeability, which are based on the pore types. At block 122, a determination is made whether the subsurface model provides satisfactory results. The satisfactory results may include computing the value of an objective function and determining whether the value of the objective function is below a threshold value. If the subsurface model does not provide satisfactory results, the subsurface model may be updated, as shown in block 124. The updating of the subsurface model may include adjusting the properties in the subsurface model and/or updating the framework or structure in the subsurface model. Then, the updates to the subsurface model may be provided to perform additional modeling of the subsurface model, as shown in block 120. If the subsurface model does provide satisfactory results, the subsurface model may be output, as shown in block 126. The outputting of the subsurface model may include displaying and/or storing the subsurface model and associated properties.

At block 128, the reservoir simulation is performed based on the outputted model results. The performance of the simulation may include performing the calculations and/or modeling fluid flow. The performance of the simulation may include modeling the fluid flow for various time steps. The simulation results may be output by displaying the simulation results on a monitor and/or storing the simulation results in memory of a computer system. Performing the simulation may include modeling fluid flow based on the subsurface model and the associated properties stored within the cells of the subsurface model. The simulation results may include the computation of time-varying fluid pressure and fluid compositions (e.g., oil, water, and gas saturation) and the prediction of fluid volumes produced or injected at wells. Performing the simulation may also include modeling fluid and/or structural changes based on the subsurface model and the associated properties stored within the mesh elements of the subsurface model. The simulation results may be output by displaying the simulation results on a monitor and/or storing the simulation results in memory of a computer system.

Then, the simulation results are for hydrocarbon operations, as shown in blocks 130. The output simulation results may be used for drilling exploration or development wells and may also be used for reservoir simulation in production phase. The hydrocarbon operations may include hydrocarbon exploration operations, hydrocarbon development operations, and/or hydrocarbon production operations. For example, the simulation results and/or the subsurface model may be used to estimate or adjust reserves forecasts, reserves estimations, and/or well performance prediction. As another example, the simulation results and/or the subsurface model may be used to adjust hydrocarbon production operations, such as installing or modifying a well or completion, modifying or adjusting drilling operations and/or installing or modifying a production facility. Further, the results may be utilized to predict hydrocarbon accumulation within the subsurface region; to provide an estimated recovery factor; and/or to determine rates of fluid flow for a subsurface region. The production facility may include one or more units to process and manage the flow of production fluids, such as hydrocarbons and/or water, from the formation.

Beneficially, this method provides an enhancement in the production, development, and/or exploration of hydrocarbons. In particular, the method may be utilized to enhance development of subsurface models that properly characterize and account for pore types and the associated influence of such pore types in the subsurface region. Further, the results may provide an enhanced subsurface model with less computational effort, less interactive intervention, and/or in a computationally efficient manner. As a result, this may provide enhancements to production at lower costs and lower risk.

As may be appreciated, the blocks of FIG. 1 may be omitted, repeated, performed in a different order, or augmented with additional steps not shown. Some steps may be performed sequentially, while others may be executed simultaneously or concurrently in parallel.

Persons skilled in the technical field will readily recognize that in practical applications of the disclosed methodology, it is partially performed on a computer, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “processing” or “computing”, “calculating”, “comparing”, “determining”, “displaying”, “copying,” “producing,” “storing,” “adding,” “applying,” “executing,” “maintaining,” “updating,” “creating,” “constructing” “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Embodiments of the present techniques also relate to an apparatus for performing the operations herein. This apparatus may be specially constructed for the required purposes, or it may comprise a general-purpose computer selectively activated or reconfigured by a computer program stored in the computer (e.g., one or more sets of instructions). Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.)).

Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present techniques are in no way limited to implementation in any specific operating system or environment.

By way of example, a simplified representation for subsurface structures is utilized to create subsurface models, which may be used in hydrocarbon operations. Thus, the present techniques may be used to enhance construction of subsurface models, which may be used for hydrocarbon operations and, more particularly, to subsurface modeling. For a subsurface model, a structural framework is created from subsurface measurements. The structural framework may include various objects, such as faults, faults, horizons, and if necessary, one or more surfaces that bound the area of interest. In addition, the structural framework may include pore type characterizations to enhance the creation of the subsurface model. The different objects are meshed to define closed volumes (e.g., zones, compartments, or subvolumes). Then, the closed volumes may be partitioned into small cells defined by the grid. Finally, properties are assigned to cells or objects (e.g., surface transmissibility) and individual cells (e.g., pore type, pore type permeability, pore type saturation, and/or pore type porosity) in the structural framework to form the subsurface model. The subsurface model may be upscaled to perform a simulation.

The present techniques may be utilized to enhance the creation of a subsurface model. The subsurface model, which may include a reservoir model, geomechanical model and/or geologic model, is a computerized representation of a subsurface region based on geophysical and geological observations associated with at least a portion of the specified subsurface region. In particular, the subsurface model may account for the influence of pore types, as noted above. Subsurface models, such as reservoir models, may be used as input data for reservoir simulators or reservoir simulation programs that compute predictions for the behavior of rocks and fluids contained within a subsurface region under various scenarios of hydrocarbon recovery. Using subsurface models in simulations provides a mechanism to identify which recovery options offer the most efficient, and effective development plans for a subsurface region (e.g., a particular reservoir and/or field). Accordingly, accounting for pore types influence may enhance the simulations.

Construction of a subsurface model for a fluid flow simulation is typically a multistep process. Initially, a structural model or structural framework is created from objects (e.g., surfaces, such as faults, horizons, and if necessary, additional surfaces that bound the area of interest for the model). The object may be adjusted or include pore type characterizations and/or even pore type permeability, pore type saturation, and/or pore type porosity. The different objects define closed volumes, which may be referred to as zones, subvolumes, compartments and/or containers. Then, each zone is meshed or partitioned into sub-volumes (e.g., cells, mesh elements or voxels) defined by a mesh (e.g., a 3-D mesh or 3-D grid). Once the partitioning is performed, properties are assigned to objects and individual sub-volumes. The objects (e.g., surfaces) are represented as meshes, while the mesh elements form a mesh. Then, the assignment of properties is often also a multistep process where mesh elements are assigned properties. The properties may be assigned in the creation of the subsurface model. For example, properties may include pore type permeability, pore type saturation, and/or pore type porosity, which may be based on the pore type categories or characterizations determined by the present techniques. Accordingly, the method may include performing the various calculations, as noted above in associated discuss and flow charts.

Further, one or more embodiments may include methods that are performed by executing one or more sets of instructions to perform modeling enhancements in various stages. For example, FIG. 2 is a block diagram of a computer system 200 that may be used to perform any of the methods disclosed herein. A central processing unit (CPU) 202 is coupled to system bus 204. The CPU 202 may be any general-purpose CPU, although other types of architectures of CPU 202 (or other components of exemplary system 200) may be used as long as CPU 202 (and other components of system 200) supports the inventive operations as described herein. The CPU 202 may execute the various logical instructions according to disclosed aspects and methodologies. For example, the CPU 202 may execute machine-level instructions for performing processing according to aspects and methodologies disclosed herein.

The computer system 200 may also include computer components such as a random access memory (RAM) 206, which may be SRAM, DRAM, SDRAM, or the like. The computer system 200 may also include read-only memory (ROM) 208, which may be PROM, EPROM, EEPROM, or the like. RAM 206 and ROM 208 hold user and system data and programs, as is known in the art. The computer system 200 may also include an input/output (I/O) adapter 210, a graphical processing unit (GPU) 214, a communications adapter 222, a user interface adapter 224, and a display adapter 218. The I/O adapter 210, the user interface adapter 224, and/or communications adapter 222 may, in certain aspects and techniques, enable a user to interact with computer system 200 to input information.

The I/O adapter 210 preferably connects a storage device(s) 212, such as one or more of hard drive, compact disc (CD) drive, floppy disk drive, tape drive, etc. to computer system 200. The storage device(s) may be used when RAM 206 is insufficient for the memory requirements associated with storing data for operations of embodiments of the present techniques. The data storage of the computer system 200 may be used for storing information and/or other data used or generated as disclosed herein. The communications adapter 222 may couple the computer system 200 to a network (not shown), which may enable information to be input to and/or output from system 200 via the network (for example, a wide-area network, a local-area network, a wireless network, any combination of the foregoing). User interface adapter 224 couples user input devices, such as a keyboard 228, a pointing device 226, and the like, to computer system 200. The display adapter 218 is driven by the CPU 202 to control, through a display driver 216, the display on a display device 220. The subsurface model, simulation results and/or scanning curves may be displayed, according to disclosed aspects and methodologies.

The architecture of system 200 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

As may be appreciated, the method may be implemented in machine-readable logic, such that a set of instructions or code that, when executed, performs the instructions or operations from memory. By way of example, the computer system includes a processor; an input device and memory. The input device is in communication with the processor and is configured to receive input data associated with a subsurface region. The memory is in communication with the processor and the memory has a set of instructions, wherein the set of instructions, when executed, are configured to: obtain subsurface data associated with a subsurface region; quantify pore types based on the subsurface data; create a pore type distribution based on the quantified pore types; create one or more property distributions based on the pore type distribution; assign one or more properties to a subsurface model based on the created one or more property distributions; and output the subsurface model along with the one or more properties.

In yet another configuration, the set of instructions, when executed by the processor, may be configured to: identify the subsurface region for pore type quantification; define dynamic rock types from the quantified pore types, and use the defined dynamic rock types in the creation of the pore type distribution; generate a pore type vertical distribution from the defined dynamic rock types, and use the pore type vertical distribution in the creation of the pore type distribution; quantify the pore type into two or more of microporosity, interparticle porosity, separate vugs and touching vugs; create a subsurface model associated with a subsurface region, wherein the subsurface model comprises a plurality of cells, and assign one or more of the properties to each of the plurality of cells; and/or simulate fluid flow within the subsurface model based on the one or more properties.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. As such, it will be apparent, however, to one skilled in the art, that many modifications and variations to the embodiments described herein are possible. All such modifications and variations are intended to be within the scope of the present invention, as defined by the appended claims.

1. A method for enhancing hydrocarbon operations for a subsurface region comprising:
obtaining subsurface data associated with a subsurface region;
quantifying pore types based on the subsurface data;
creating a pore type distribution based on the quantified pore types;
creating one or more property distributions based on the pore type distribution;
assigning one or more properties to a subsurface model based on the created one or more property distributions; and
outputting the subsurface model along with the one or more properties.

2. The method of claim 1, further comprising identifying the subsurface region for pore type quantification.

3. The method of claim 1, wherein the one or more property distributions comprise pore type porosity distribution.

4. The method of claim 1, wherein the one or more property distributions comprise pore type-saturation distribution.

5. The method of claim 1, wherein the one or more property distributions comprise pore type-permeability distribution.

6. The method of claim 1, further comprising:
defining dynamic rock types from the quantified pore types; and
using the defined dynamic rock types in the creation of the pore type distribution.

7. The method of claim 6, further comprising:
generating a pore type vertical distribution from the defined dynamic rock types; and
using the pore type vertical distribution in the creation of the pore type distribution.

8. The method of claim 1, wherein the pore type comprise two or more of microporosity, interparticle porosity, separate vugs and touching vugs.

9. The method of claim 1, further comprising:
creating the subsurface model associated with a subsurface region, wherein the subsurface model comprises a plurality of cells;
assigning one or more of the properties to each of the plurality of cells.

10. The method of claim 1, further comprising simulating fluid flow within the subsurface model based on the one or more properties.

11. The method of claim 10, further comprising causing a well to be drilled based on the one of the outputted properties, the simulated fluid flow, and any combination thereof.

12. The method of claim 10, comprising performing a hydrocarbon operation based on the one of the outputted properties, the simulated fluid flow, and any combination thereof.

13. A system for enhancing hydrocarbon operations associated with a subsurface region, comprising:
a processor;
an input device in communication with the processor and configured to receive input data associated with a subsurface region;
memory in communication with the processor, the memory having a set of instructions, wherein the set of instructions, when executed by the processor, are configured to:
obtain subsurface data associated with a subsurface region;
quantify pore types based on the subsurface data;
create a pore type distribution based on the quantified pore types;
create one or more property distributions based on the pore type distribution;
assign one or more properties to a subsurface model based on the created one or more property distributions; and
output the subsurface model along with the one or more properties.

14. The system of claim 13, wherein the set of instructions, when executed by the processor, are configured to: identify the subsurface region for pore type quantification.

15. The system of claim 13, wherein the set of instructions, when executed by the processor, are configured to:
define dynamic rock types from the quantified pore types; and
use the defined dynamic rock types in the creation of the pore type distribution.

16. The system of claim 13, wherein the set of instructions, when executed by the processor, are configured to:
generate a pore type vertical distribution from the defined dynamic rock types; and
use the pore type vertical distribution in the creation of the pore type distribution.

17. The system of claim 13, wherein the set of instructions, when executed by the processor, are configured quantify the pore type into two or more of microporosity, interparticle porosity, separate vugs and touching vugs.

18. The system of claim 13, wherein the set of instructions, when executed by the processor, are configured to:
create a subsurface model associated with a subsurface region, wherein the subsurface model comprises a plurality of cells;
assign one or more of the properties to each of the plurality of cells.

19. The system of claim 13, wherein the set of instructions, when executed by the processor, are configured to simulating fluid flow within the subsurface model based on the one or more properties.
